(19) United States
(12) Patent Application Publication
(10) Pub. No.: US 2024/0383444 A1
(43) Pub. Date: Nov. 21, 2024

(54) EXTERNAL DETECTION APPARATUS FOR VEHICLE

(71) Applicant: Honda Motor Co., Ltd., Tokyo (JP)

(72) Inventors: Ryota OKUTSU, Tokyo (JP); Motoki CHIBA, Tokyo (JP)

(73) Assignee: Honda Motor Co., Ltd., Tokyo (JP)

(21) Appl. No.: 18/622,999

(22) Filed: Mar. 31, 2024

(30) Foreign Application Priority Data
May 16, 2023 (CN) 202310545822.7

(51) Int. Cl. B60S 1/08; B60S 1/56

(52) U.S. Cl. CPC B60S 1/0818; B60S 1/56

(57) ABSTRACT

Disclosed is an external detection apparatus for vehicle that provides driving assistance based on the output of a detection apparatus mounted on the vehicle for detecting the outside. The external detection apparatus for vehicle includes a cleaning device, a performance degradation detection device and a determining device. The cleaning device is used to clean the surface of the detection apparatus exposed to the outside in the detection direction. The performance degradation detection device is used to detect degradation of detection performance of the detection apparatus. The determining device is used to judge whether contamination can be removed. The cleaning device is operated based on the detection result of the performance degradation detection device and the judgment result of the determining device.

### CROSS-REFERENCE TO RELATED APPLICATION

This application claims the priority benefit of Chinese application serial no. 202310545822.7, filed on May 16, 2023. The entirety of the above-mentioned patent application is hereby incorporated by reference herein and made a part of this specification.

### BACKGROUND

### Technical Field

The present disclosure relates to a detection apparatus, and in particular to an external detection apparatus for vehicle.

### Description of Related Art

In recent years, proactive efforts have been made to provide access to sustainable transportation systems that also take into account the disadvantaged people in transportation. In order to achieve the above purpose, research and development have been carried out to further improve the safety and convenience of transportation through the development of driving assistance technologies.

Patent Document 1 (JP Laid-Open No. 2009-243963) discloses an object detection apparatus that displays a message “contaminated radome” on a display screen when it is determined that the detection performance of a millimeter-wave radar or the like has deteriorated. Patent Document 2 (JP Laid-Open No. 2001-199260) discloses a vehicle-to-vehicle distance control device that, when detecting contamination on the camera, notifies the driver that contamination is detected, sprays water on the windshield, and operates the wipers to remove the contamination.

However, when the performance of a sensor degrades, vehicle control functions cannot continue by warning the driver or requesting operations. On the other hand, when cleaning fluid is sprayed to remove contamination, the surface of the sensor is covered with a water film and detection cannot be performed temporarily, so the vehicle control function may not be able to continue.

In terms of vehicle driving stability, how to maintain vehicle control functions when the sensors are contaminated is to be explored by practitioners in this field.

### SUMMARY

In order to solve the above-mentioned problems, the disclosure aims at maintaining the vehicle control function by removing contamination from the sensor at an appropriate time, and in turn contribute to the development of sustainable transportation systems.

In order to achieve the above purpose, the present disclosure is an external detection apparatus for vehicle that provides driving assistance based on the output of a detection apparatus mounted on the vehicle for detecting the outside. An external detection apparatus for vehicle includes a cleaning device, a performance degradation detection device and a determining device.

The cleaning device is disposed to clean the surface of the detection apparatus exposed to the outside in the detection direction. The performance degradation detection device is disposed to detect degradation of detection performance of the detection apparatus. The determining device is disposed to judge whether the contamination may be removed. The cleaning device is operated based on the detection result of the performance degradation detection device and the judgment result of the determining device.

Based on the above, the external detection apparatus for vehicle of the present disclosure determines the contamination on the sensor, the operation status of other sensors and the target of the area around the vehicle, and uses cleaning spray to remove the contamination based on the above information. Accordingly, the external detection apparatus for vehicle of the present disclosure removes contamination from sensor at a time when the impact of performance degradation caused by the water film of the cleaning fluid is small, thereby maintaining the vehicle control function.

In order to make the above-mentioned features and advantages of the present disclosure more clear and understandable, the following embodiments are specifically described in detail with reference to the accompanying drawings.

### BRIEF DESCRIPTION OF THE DRAWINGS

FIG. 1 is a schematic block diagram of an external detection apparatus for vehicle according to an embodiment of the present disclosure.

FIG. 2 is a flow chart of a decontamination method performed by an external detection apparatus for vehicle according to an embodiment of the present disclosure.

FIG. 3 is a schematic diagram of setting a performance degradation threshold according to an embodiment of the present disclosure.

FIG. 4 is a flow chart of a method for determining the extent of performance degradation according to an embodiment of the present disclosure.

FIG. 5 is a flow chart of a method for determining the extent of performance degradation according to an embodiment of the present disclosure.

FIG. 6 is a schematic diagram of an alternative detection apparatus according to an embodiment of the present disclosure.

FIG. 7A and FIG. 7B are schematic diagrams of determining objects in the detection area according to an embodiment of the present disclosure.

FIG. 8 is a flow chart of a decontamination method according to an embodiment of the present disclosure.

### DESCRIPTION OF THE EMBODIMENTS

Reference will now be made in detail to the exemplary embodiments of the present disclosure, examples of which are illustrated in the accompanying drawings. Whenever possible, the same reference numbers are used in the drawings and descriptions to refer to the same or similar parts.

The embodiment of the present disclosure determines whether decontamination needs to be performed based on the extent of performance degradation of sensors related to vehicle control functions. Decontamination is performed under the following circumstances: when the contaminated sensor is not used in function, when the detection range overlaps each other or when other alternative sensors are normal, or when no object is detected in the surrounding predetermined area. In this way, it is possible to maintain vehicle control function while removing contamination from sensor.

In an embodiment of the present disclosure, the detection apparatus includes at least one of radar, LiDAR, camera, ultrasound and infrared.

In an embodiment of the present disclosure, the external detection apparatus for vehicle includes a plurality of detection apparatuses, and the determining device determines whether the detection apparatuses other than the detection apparatus are normal.

In an embodiment of the present disclosure, the determining device makes a judgment based on whether the currently executed driving assistance function requires a detection apparatus.

In an embodiment of the present disclosure, the determining device makes a judgment based on whether there is an object in the detection area of the detection apparatus.

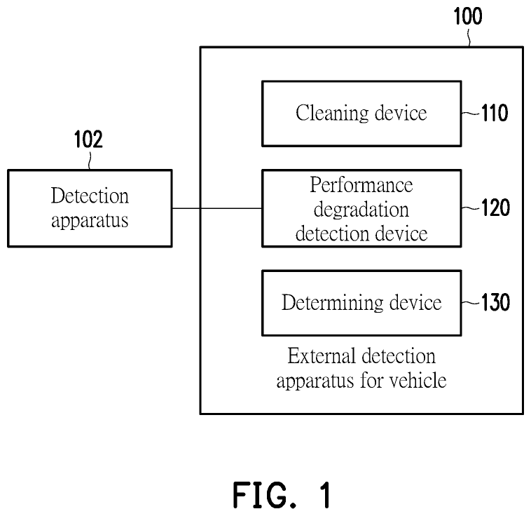

FIG. 1 is a schematic block diagram of an external detection apparatus for vehicle according to an embodiment of the present disclosure. Referring to FIG. 1, the external detection apparatus 100 for vehicle of this embodiment is disposed in, for example, the own vehicle, and provides driving assistance based on the output of the detection apparatus 102 mounted on the own vehicle for detecting the outside. In this embodiment, the own vehicle includes, for example, a car using an internal combustion engine such as a diesel engine or a gasoline engine as a power supply, an electric car using an electric motor as a power supply, a hybrid car having both an internal combustion engine and an electric motor, and the like.

The detection apparatus 102 is, for example, a radar, light detection and ranging (LiDAR), camera, ultrasonic, infrared, or other device disposed outside the vehicle to detect external conditions. This embodiment provides no limitation to the type of the detection apparatus 102. The detection apparatus is, for example, used in automatic driving systems such as Advanced

Driver Assistance Systems (ADAS) and Adaptive Cruise Control (ACC) systems to support automatic driving functions, or is applied in Autonomous Emergency Braking (AEB) system to support the emergency braking function. This embodiment provides no limitation to the functions supported by the detection apparatus.

The external detection apparatus 100 for vehicle includes a cleaning device 110, a performance degradation detection device 120 and a determining device 130. Some or all of the above devices may be implemented by a processor executing a program. Moreover, some or all of the above devices may also be implemented through hardware such as Large Scale Integration (LSI) or Application Specific Integrated Circuit (ASIC), or by a combination of software and hardware. The embodiment provides no limitation to the implementation thereof.

The cleaning device 110 includes, for example, a cleaning spray, a wiper, or a combination thereof. The cleaning spray and wiper are, for example, disposed around the detection apparatus 102 for cleaning the surface of the detection apparatus 102 that is exposed to the outside in the detection direction.

The performance degradation detection device 120 is disposed to detect degradation in the detection performance of the detection apparatus 102. The performance degradation detection device 120 determines the extent of degradation of the detection performance of the detection apparatus 102 by, for example, comparing the current detection result of the detection apparatus 102 with the detection result when the detection apparatus 102 is normal.

The determining device 130 is disposed to determine whether the decontamination can be performed. In some embodiments, the determining device 130 may determine whether decontamination can be performed by checking whether other detection apparatuses other than the detection apparatus 102 in the own vehicle are normal, whether the currently executed driving assistance function requires the detection apparatus 102 or whether there are objects in the detection area of the detection apparatus 102. In this way, it is possible to ensure that the decontamination process does not affect the operation of the vehicle control function, but this embodiment is not limited to the above determining method.

The cleaning device 110 is operated based on the detection result of the performance degradation detection device 120 and the judgment result of the determining device 130.

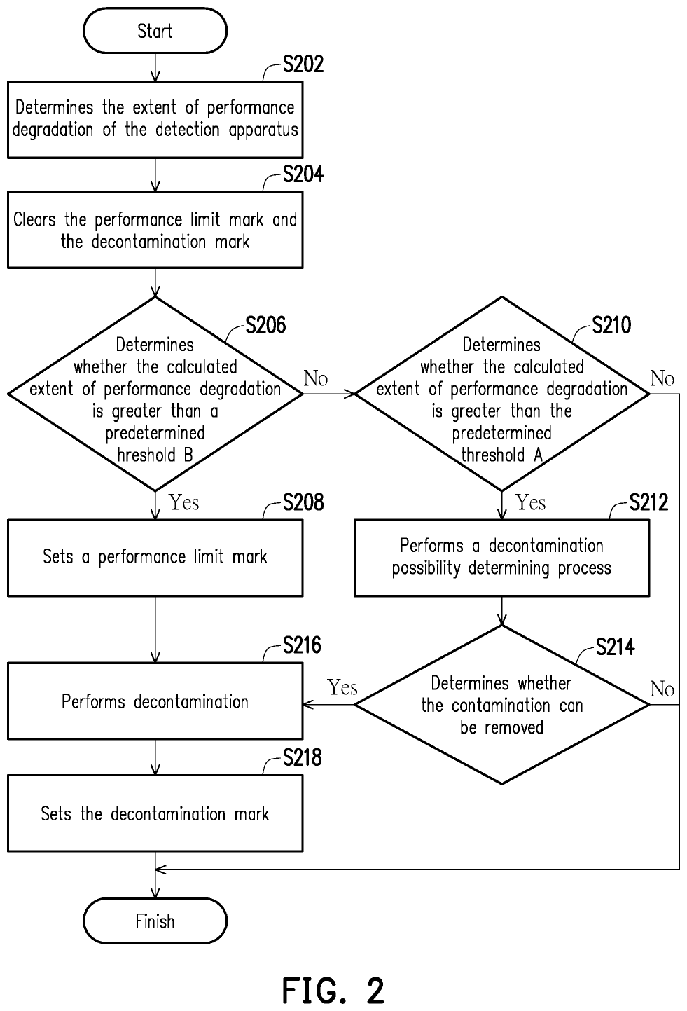

Specifically, FIG. 2 is a flow chart of a decontamination method performed by an external detection apparatus for vehicle according to an embodiment of the present disclosure. Please refer to FIG. 1 and FIG. 2. The method of this embodiment is applicable to the external detection apparatus 100 for vehicle of FIG. 1. The detailed steps of the decontamination method of this embodiment will be described below with reference to various components in the external detection apparatus 100 for vehicle.

In step S202, the external detection apparatus 100 for vehicle determines the extent of performance degradation of the detection apparatus 102 by the performance degradation detection device 120. The performance degradation detection device 120 may, for example, calculate the extent of performance degradation of the detection apparatus 102 and evaluate whether the detection apparatus 102 needs to be cleaned.

In some embodiments, the performance degradation detection device 120 will, for example, compare the number of LiDAR points currently obtained by the detection apparatus 102 with the predetermined number of points detected when the detection apparatus 102 is running normally, and use the ratio of the obtained points to the predetermined points as the calculated extent of performance degradation of the detection apparatus 102. However, in other embodiments, for different types of detection apparatuses 102, the performance degradation detection device 120 may use different methods to calculate the extent of performance degradation, and this embodiment does not limit the calculation method.

In step S204, the performance degradation detection device 120 clears the performance limit mark and the decontamination mark. In this embodiment, the performance degradation detection device 120 sets the performance limit mark according to the judgment result of the extent of performance degradation, and the cleaning device 110 sets the decontamination mark after the decontamination operation is performed, so that the cleaning device 110 may determine whether to perform decontamination forcibly on the detection apparatus 102 based on the performance limit mark, and the performance degradation detection device 120 may decide whether to stop functions in operation based on the decontamination mark.

In step S206, the performance degradation detection device 120 determines whether the calculated extent of performance degradation is greater than a predetermined threshold B. Specifically, for example, the performance degradation detection device 120 sets thresholds A and B for the extent of performance degradation based on the performance limit of the detection apparatus 102 in maintaining the function thereof, thereby determining whether the detection apparatus 102 is still able to maintain the functions that the detection apparatus 102 supports after the performance thereof is degraded, or whether the detection apparatus 102 has been unable to maintain the function.

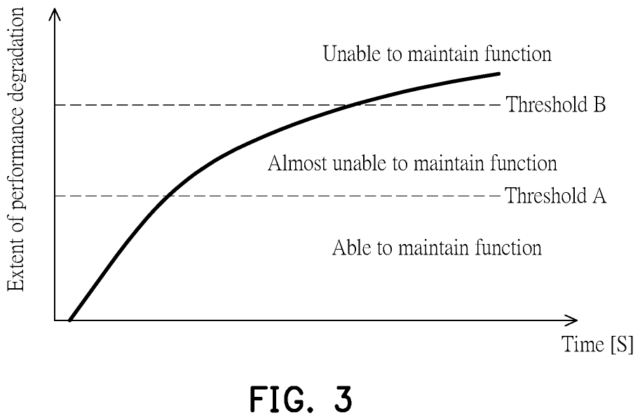

For example, FIG. 3 is a schematic diagram of setting a performance degradation threshold according to an embodiment of the present disclosure. Please refer to FIG. 3. This embodiment illustrates a curve C showing the change the extent of performance degradation of the detection apparatus over time, wherein the vertical axis is the extent of performance degradation, the horizontal axis is time, and the unit is seconds(s). This embodiment sets thresholds A and B according to the extent of performance degradation. If the extent of performance degradation of the detection apparatus is less than the threshold A, it may be determined that the detection apparatus is able to maintain the function thereof; if the extent of performance degradation of the detection apparatus is greater than the threshold B, it may be determined that the detection apparatus is no longer able to maintain the function thereof. If the extent of performance degradation of the detection apparatus is between the threshold A and the threshold B, it may be determined that the detection apparatus is nearly unable to maintain the function thereof.

In step S206, if it is determined that the extent of performance degradation is greater than the threshold B, it may be determined that the detection apparatus 102 is no longer able to maintain the function thereof. Under the circumstances, step S208 will be performed, and the performance degradation detection device 120 sets a performance limit mark. On the contrary, if it is determined that the extent of performance degradation is not greater than the threshold B, step S210 will be performed, and the performance degradation detection device 120 further determines whether the calculated extent of performance degradation is greater than the predetermined threshold A.

In step S210, if it is determined that the extent of performance degradation is greater than the threshold A, it may be determined that the detection apparatus 102 may remove contamination through cleaning by the cleaning device 110, and then step S212 is performed, where the determining device 130 performs a decontamination possibility determining process. On the contrary, if it is determined that the extent of performance degradation is not greater than the threshold A, it may be determined that the detection apparatus 102 is able to maintain the function, and the process ends.

In some embodiments, the determining device 130 may perform the decontamination possibility determining process by checking whether other detection apparatuses other than the detection apparatus 102 in the own vehicle are normal, whether the currently executed driving assistance function requires the detection apparatus 102 or whether there are objects in the detection area of the detection apparatus 102. The above determining methods will be described in detail below with examples.

In step S214, the determining device 130 determines whether the contamination can be removed based on the result of the contamination possibility determining process. If it is determined that the contamination can be removed, step S216 is performed, and the cleaning device 110 performs decontamination. The cleaning device 110 may remove contamination on the surface of the detection apparatus 102 by spraying cleaning fluid on the surface of the detection apparatus 102 that is exposed to the outside in the detection direction, and scraping off the cleaning fluid with a wiper.

After performing the decontamination operation, in step S218, the cleaning device 110 will set the decontamination mark. Specifically, when the performance degradation detection device 120 determines the extent of performance degradation of the detection apparatus 102 (step S202), the decontamination operation on the detection apparatus 102 by the cleaning device 110 may be obtained from this decontamination mark. If the extent of performance degradation of the detection apparatus 102 has not been improved after decontamination, it may be determined that the detection apparatus 102 is faulty and unable to support its corresponding function, and the operation of the function is stopped accordingly.

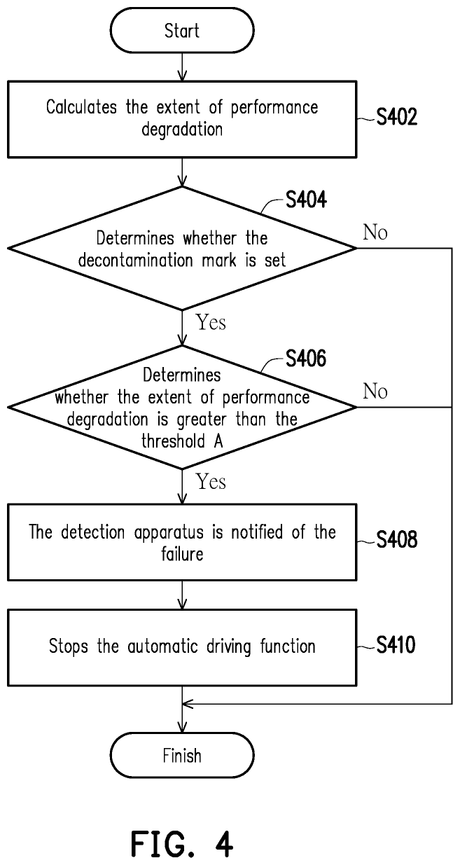

Specifically, FIG. 4 is a flow chart of a method for determining the extent of performance degradation according to an embodiment of the present disclosure. Please refer to FIG. 1 and FIG. 4. The method of this embodiment is applicable to the performance degradation detection device 120 of FIG. 1. The detailed steps of the performance degradation extent determining method of this embodiment are described below.

In step S402, the performance degradation detection device 120 calculates the extent of performance degradation of the detection apparatus 102. Specifically, the performance degradation detection device 120 may calculate the ratio of the number of LiDAR points currently obtained by the detection apparatus 102 and the predetermined number of points detected when the detection apparatus 102 operates normally, and the obtained ratio is used as the extent of performance degradation of the detection apparatus 102.

In step S404, the performance degradation detection device 120 determines whether the decontamination mark is set. If the decontamination mark is set, it means that the cleaning device 110 has performed a decontamination operation on the detection apparatus 102. Under the circumstances, the performance degradation detection device 120 will determine whether the calculated extent of performance degradation is greater than the threshold A in step S406.

If it is determined in step S404 that the decontamination mark is not set or it is determined in step S406 that the extent of performance degradation is not greater than the threshold A, it means that the detection apparatus 102 is able to maintain the function thereof, and the process ends.

If it is determined in step S406 that the extent of performance degradation is greater than the threshold A, the performance degradation detection device 120 may determine that even if a decontamination operation is performed on the detection apparatus 102, the function still cannot be restored, and therefore, in step S408, the detection apparatus 102 is notified of the failure. The performance degradation detection device 120 may notify the detection apparatus 102 of the failure by displaying a fault light signal, information, or playing fault sound effects or voice message. This embodiment does not limit the notification method.

In step S410, the performance degradation detection device 120 will stop the automatic driving function of the own vehicle. Specifically, the detection apparatus 102 is no longer able to support the automatic driving function. Therefore, by automatically stopping the function, it is possible to prevent the automatic driving function from malfunctioning and endangering driving safety. In addition, the subsequent sensor decontamination process may be interrupted.

In the above embodiment, the performance degradation detection device 120 determines that the detection apparatus 102 is faulty when the extent of performance degradation of the detection apparatus 102 after decontamination has not been restored to the normal state. In other embodiments, the performance degradation detection device 120 may also determine whether the detection apparatus 102 is faulty based on the number of times the performance is judged to be abnormal based on the extent of performance degradation within a certain period of time. This embodiment does not limit the determining method.

FIG. 5 is a flow chart of a method for determining the extent of performance degradation according to an embodiment of the present disclosure. Please refer to FIG. 1, FIG. 2 and FIG. 5. This embodiment illustrates the detailed flow of the decontamination possibility determining process performed by the determining device 130 in step S212 in FIG. 2.

In step S502, the determining device 130 determines the function currently operated by the own vehicle.

In step S504, the determining device 130 determines whether the function of the contaminated detection apparatus 102 required is running, so as to determine whether the decontamination operation may be performed. For example, assuming that the contaminated detection apparatus 102 is a LiDAR, and the current function of the own vehicle is an autonomous driving function that requires LiDAR, if a decontamination operation is performed on the contaminated detection apparatus 102, the operation might affect the automatic driving function. Therefore, it is necessary to further confirm whether there is other detection apparatus that can replace the contaminated detection apparatus 102 before determining whether the contaminated detection apparatus 102 can be decontaminated.

For example, Table 1 below lists the operating functions of the own vehicle and the sensor used by the own vehicle. As shown in Table 1, the function A only requires sensor B, function B requires sensors A and B, and function C requires sensors A, B, and C. In the state where only function A is operating, if sensor A is determined to be contaminated, it will be determined that the decontamination operation can be performed because the sensor A does not affect the operation of function A. If the sensor B is determined to be contaminated, since the sensor B will affect the operation of function A, it is determined that the decontamination operation cannot be performed.

TABLE 1

| | Function A | Function B | Function C |
|---|---|---|---|
| Sensor A | x | ∘ | ∘ |
| Sensor B | ∘ | ∘ | ∘ |
| Sensor C | x | x | ∘ |
| In operation | ∘ | x | x |

Therefore, if it is determined that the function of the contaminated detection apparatus 102 required is not running, step S516 will be performed, and the determining device 130 determines that the decontamination operation can be performed. On the contrary, if it is determined that the function of the contaminated detection apparatus 102 required is running, then in step S506, the determining device 130 will determine the operation status of other detection apparatuses, and in step S508, the determining device 130 will determine whether the other detection apparatuses are abnormal. The other detection apparatus is, for example, a detection apparatus whose detection range overlaps with the contaminated detection apparatus 102, or a detection apparatus whose detection function may replace the function of the detection apparatus 102. This embodiment provides no limitation to the type of the detection apparatus.

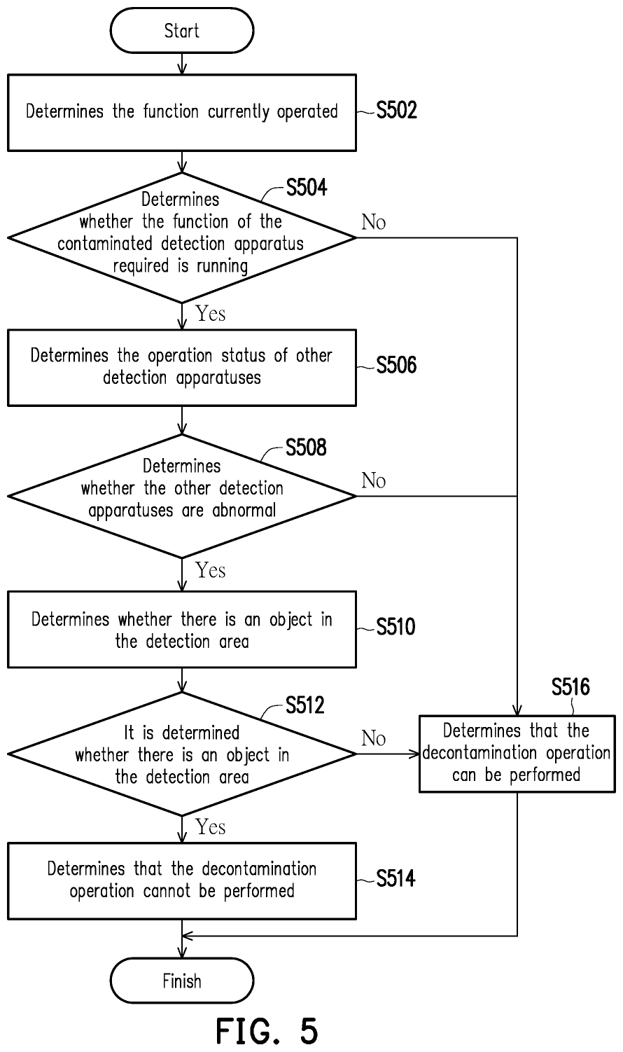

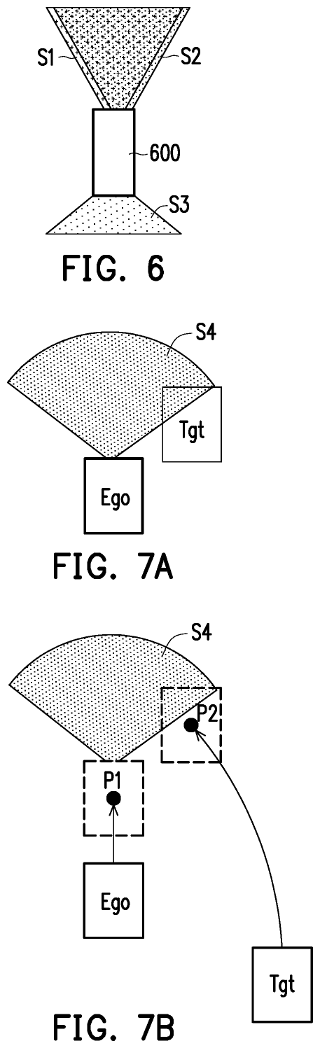

For example, FIG. 6 is a schematic diagram of an alternative detection apparatus according to an embodiment of the present disclosure. Referring to FIG. 6, for example, the own vehicle 600 is equipped with sensors A, B, and C, whose detection ranges are S1, S2, and S3 respectively. Specifically, most of the detection ranges S1 and S2 overlap each other, so the sensors A and B may be substitute sensors for each other. That is, if the sensor A is contaminated and the sensor B is normal, a decontamination operation may be performed on the sensor A.

If it is determined that other detection apparatuses are not abnormal, it means that the contaminated detection apparatus can be replaced with other detection apparatuses. Under the circumstances, step S516 will be performed, and the determining device 130 determines that the decontamination operation can be performed.

On the contrary, if there is no other detection apparatus that can be replaced in terms of function, or if the other detection apparatus that may be used for replacement is abnormal, it may be determined that the decontamination operation cannot be performed on the contaminated detection apparatus. Under the circumstances, in step S510 of this embodiment, the determining device 130 determines whether there is an object in the detection area of the detection apparatus 102, and in step S512, it is determined whether there is an object in the detection area. Specifically, the determining device 130 may determine whether there is an object in the detection area of the detection apparatus 102, for example, when the detection apparatus 102 has not reached the performance limit thereof. Alternatively, other detection apparatus (for example, a camera) different from the detection apparatus 102 may be used to determine whether there is an object within the detection area of the detection apparatus 102.

If it is determined that there is an object in the detection area, then in step S514, the determining device 130 determines that the decontamination operation cannot be performed. On the contrary, if it is determined that there is no object in the detection area, then in step S516, the determining device 130 determines that the decontamination operation can be performed.

For example, FIG. 7A and FIG. 7B are schematic diagrams of determining objects in the detection area according to an embodiment of the present disclosure. Please refer to FIG. 7A. The own vehicle Ego may identify the position of the surrounding object Tgt through the current sensor (i.e., contaminated sensor) or other sensors, and determine whether the object Tgt interferes with the detection range S4 of the current sensor (i.e., a part of the object Tgt is within the detection range S4). If interference occurs, it is determined that the decontamination operation cannot be performed on the current sensor. Referring to FIG. 7B, the own vehicle Ego may identify the position, moving speed and moving direction of the surrounding object Tgt through the current sensor (that is, the contaminated sensor) or other sensors, so as to evaluate whether the object Tgt will interfere with the detection range S4 of the current sensor after a predetermined time. That is, the own vehicle Ego moves to the position P1 after a predetermined time, and the object Tgt moves to the position P2 after a predetermined time. At this point in time, the own vehicle Ego may determine whether the moved object Tgt interferes with the detection range S4 of the current sensor. If interference occurs, it is determined that the decontamination operation cannot be performed on the current sensor. The above-mentioned predetermined time is, for example, the time required to perform a decontamination operation (including spraying and scraping off cleaning fluid) on the current sensor.

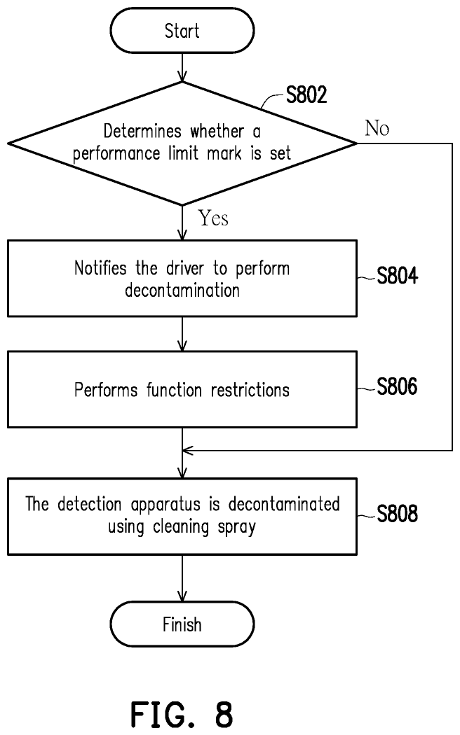

FIG. 8 is a flow chart of a decontamination method according to an embodiment of the present disclosure. Please refer to FIG. 1, FIG. 2 and FIG. 8. This embodiment illustrates the detailed process of decontamination performed by the cleaning device 110 in step S216 in FIG. 2.

In step S802, the cleaning device 110 determines whether a performance limit mark is set. Specifically, the performance limit mark is set by the performance degradation detection device 120 when it is determined that the extent of performance degradation is greater than the threshold B, which represents that the extent of performance degradation of the detection apparatus 102 has reached the performance limit.

If it is determined that the performance limit mark is set, the cleaning device 110 will forcibly perform decontamination, which includes notifying the driver of the own vehicle to perform decontamination on the detection apparatus 102 in step S804, and performing function restrictions on the own vehicle in step S806, for example, the level of autonomous driving is reduced, and then in step S808, the detection apparatus 102 is decontaminated using cleaning spray.

On the other hand, in step S802, if it is determined that the performance limit mark is not set, the cleaning device 110 will avoid the function restriction that is set for the performance limit, directly proceed to step S808, and the cleaning spray is used to perform decontamination on the detection apparatus 102.

In summary, the external detection apparatus for vehicle of the present disclosure determines whether decontamination needs to be performed by detecting the degradation of the detection performance of the detection apparatus related to the vehicle control function. When it is determined that decontamination needs to be performed, it is further determined whether decontamination is to be performed based on whether the contaminated detection apparatus is used for running function, whether there are other detection apparatuses that may be used for replacement, or whether there is an object in the detection range. In this way, the sensor may be decontaminated while maintaining vehicle control functions. In addition, the external detection apparatus for vehicle of the present disclosure stops or limits the execution of functions when the extent of performance degradation of the detection apparatus reaches the performance limit, or when the extent of performance degradation of the detection apparatus does not return to the normal state after decontamination is performed, so as to prevent running functions from being affected by the contaminated detection apparatus and endangering driving safety.

Finally, it should be noted that the above embodiments are only used to illustrate the technical solution of the present disclosure, but not to limit it. Although the present disclosure has been described in detail with reference to the foregoing embodiments, those of ordinary skill in the art should understand that: The technical solutions described in the foregoing embodiments can still be modified, or some or all of the technical features can be equivalently replaced; and these modifications or substitutions do not deviate from the essence of the corresponding technical solutions from the scope of the technical solutions of the embodiments of the present disclosure.

What is claimed is:

1. An external detection apparatus for a vehicle, which provides driving assistance based on an output of a detection apparatus mounted on the vehicle for detecting the outside, comprising:
a cleaning device cleaning a surface of the detection apparatus exposed to the outside in a detection direction;
a performance degradation detection device detecting a degradation of a detection performance of the detection apparatus; and
a determining device determining whether a contamination is able to be removed, wherein
the cleaning device is operated based on a detection result of the performance degradation detection device and a judgment result of the determining device.

2. The external detection apparatus for the vehicle according to claim 1, wherein the detection apparatus comprises at least one of a radar, a LiDAR, a camera, ultrasound and infrared.

3. The external detection apparatus for the vehicle according to claim 1, comprising a plurality of detection apparatuses, and the determining device determines whether the plurality of detection apparatuses other than the detection apparatus are normal.

4. The external detection apparatus for the vehicle according to claim 1, wherein the determining device makes a judgment based on whether a currently executed driving assistance function requires the detection apparatus.

5. The external detection apparatus for the vehicle according to claim 1, wherein the determining device makes a judgment based on whether there is an object in a detection area of the detection apparatus.
